(19) United States
(12) Patent Application Publication
(10) Pub. No.: US 2026/0001502 A1
(43) Pub. Date: Jan. 1, 2026

(54) FRONT BUMPER ASSEMBLY

(71) Applicant: FCA US LLC, Auburn Hills, MI (US)

(72) Inventors: Zhenghong Yan, Shanghai (CN); Ziye Wang, Shanghai (CN); Dan Li, Shanghai (CN); Wenbin Song, Shanghai (CN); Bing Li, Shanghai (CN)

(21) Appl. No.: 18/758,189

(22) Filed: Jun. 28, 2024

(51) Int. Cl. B60R 19/02; B60R 19/50

(52) U.S. Cl. CPC B60R 19/023; B60R 19/50

(57) ABSTRACT

A vehicle bumper cover has a soft nose fascia and a reinforcement. A plurality of hooks, as well as a plurality of clips, are on the soft nose fascia. A plurality of channels is formed in the reinforcement to receive the hooks. A plurality of apertures is formed in the reinforcement to receive the plurality of clips. The reinforcement is elongated and extends between sides of the nose fascia to provide a securement beam to attach with a vehicle framework.

### CROSS-REFERENCE TO RELATED APPLICATIONS

The present application is related in general subject matter to pending U.S. patent application Ser. No. ______ (Attorney Docket No. 712341US1), filed concurrently herewith, entitled “Vehicle Bumper Cover Or Soft Nose Fascia,” assigned to FCA US LLC, and hereby incorporated by reference in its entirety into the present application. The present application is further related in general subject matter to pending commonly assigned U.S. patent application Ser. No. ______ (Attorney Docket No. 712342US1), filed concurrently herewith, entitled “Support Bracket For A Front Vehicle Fascia,” hereby incorporated by reference in its entirety into the present application.

### FIELD

The present disclosure relates to automotive vehicles and, more particularly, to a front bumper assembly.

### BACKGROUND

This section provides background information related to the present disclosure which is not necessarily prior art.

A front bumper assembly is received onto the vehicle frame work. The front bumper assembly is generally plastic and over a period of time is subjected to sag. The sag provides an undesirable aesthetic appearance. Thus, it would be desirable to have a front bumper fascia that is supported against sag to provide a pleasing aesthetic appearance. Accordingly, the present disclosures provides such a support.

### SUMMARY

This section provides a general summary of the disclosure, and is not a comprehensive disclosure of its full scope or all of its features.

The present disclosure provides a front bumper assembly with a reinforcement bracket with the front bumper. Also, a metal clip assembly secures the reinforcement bracket and the front bumper fascia with the framework of the bumper assembly.

According to a first aspect of the disclosure, a front bumper assembly comprises a bumper with a reinforcement member secured to the bumper for receiving a front nose fascia. A framework is coupled with the reinforcement member. The framework supports the front nose fascia. The reinforcement member is welded or the like to the bumper. The reinforcement includes a plurality of bores to receive fasteners to secure with the framework. The framework includes a plurality of channels to receive pins from the reinforcement and the front nose fascia. A clip secures to each pin to retain the front nose fascia and reinforcement onto the framework. The framework has a ledge and an extending wall. The ledge couples with the reinforcement member and the front nose fascia couples with the wall. The reinforcement member is secured to a peripheral portion of the framework. The framework includes bores to receive fasteners to secure the daytime running lamps. The framework includes a channel to receive the daytime running lights.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a bumper fascia assembly.

FIG. 2 is a rear perspective view of the assembly.

FIG. 3 is a cross-section view through line 3-3 of FIG. 2.

FIG. 4 is a perspective view of the framework and of the bumper assembly.

FIG. 5 is an exploded perspective view of the framework.

FIG. 6 is a cross-section view through FIG. 5 along line 6-6.

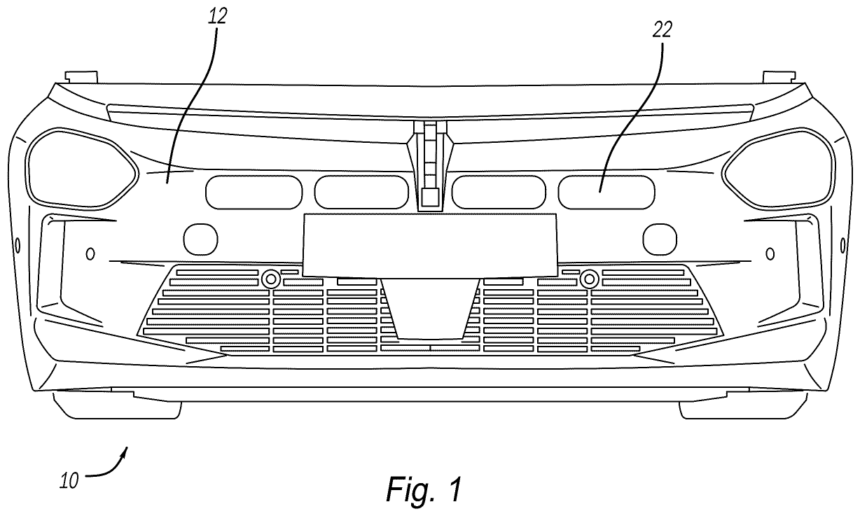

Corresponding reference numerals indicate corresponding parts throughout the several views of the drawings.

### DETAILED DESCRIPTION

Example embodiments will now be described more fully with reference to the accompanying drawings.

Turning to the figures, a front bumper assembly is illustrated and designated with the reference numeral 10. The assembly 10 includes a front fascia 12, a bumper 14, a reinforcement member 16 and a vehicle framework 18. The bumper 14 is generally an elongated rectangular member. The bumper 14 is made from a metallic material such as steel.

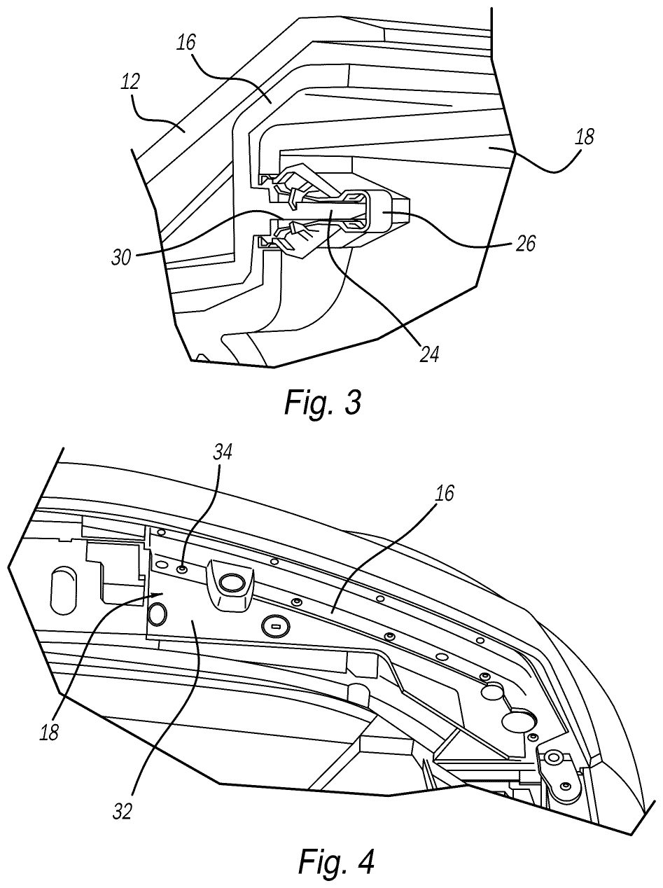

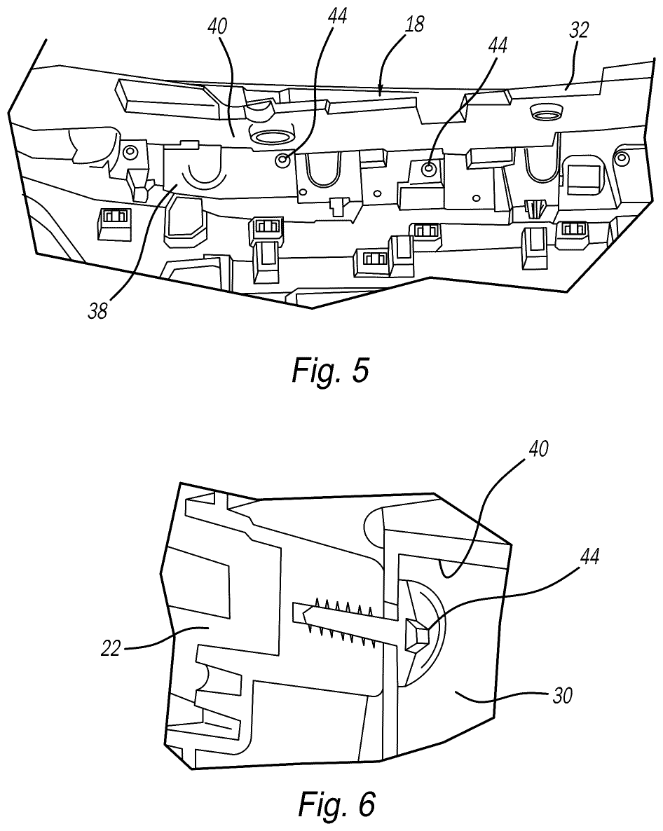

The reinforcement member 16 is welded or the like to the bumper 14. The reinforcement member 16 extends upward from the bumper 14 towards the hood of a vehicle. The reinforcement member 16 includes cutouts to enable pass through of the daytime running lamp 22. The reinforcement member 16 includes a plurality of fingers or pins 24 to be received into the framework 18. The fingers or pins 24 receive a metal clip 26 to retain the fingers or pins with the framework 18 to support the reinforcement 16 and front fascia 12. The fingers or pins 24 project through a channel 30 in the framework 18 as illustrated in FIG. 3. Thus, the framework 18 and reinforcement member 16 are secured with one another. The reinforcement member 16 spans between the fenders of the vehicle to provide support for the front fascia 12.

The framework 18 extends between the fenders and has an elongated configuration. The framework 18 includes channels 30 that receive the fingers or pins 24 so that a clip 26 can be attached to the fingers or pins 24 to secure the reinforcement member 16 with the framework 18. The reinforcement member 16 is secured with the nose fascia 12. Thus, the clips 26 can be removed and the reinforcement member 16 as well as the front fascia 12 are is removable from the framework 18.

The framework 18 includes a ledge 32 to secure with the reinforcement member 16 via a plurality of fasteners 34 extending through bores in the reinforcement member 16 and the framework 18. Thus, this secures the front fascia 12 at the top of the ledge to secure the front fascia 12 to the framework 18.

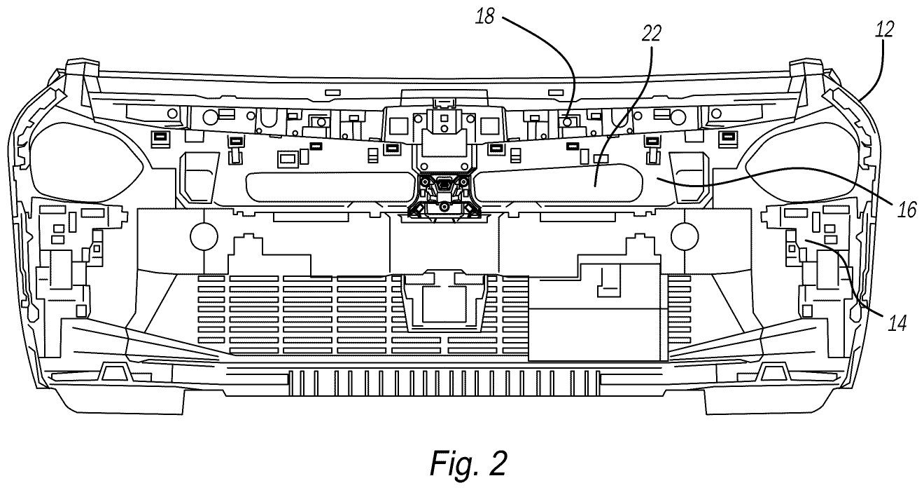

The framework 18 includes a wall 38 having a step portion 40 defining a channel 42 to receive the daylight running lamps 22. The running lamps 22 can be secured to the framework 18 via screws 44 so that they are readily removable from the framework 18 so that the front fascia can be removed from the vehicle. Also, the front fascia 12 includes arms 48 with apertures 50 to enable the front fascia to be secured to the fenders 60 along the sides of the fascia 12. Thus, the front fascia 12 as well as the reinforcement member 16 and framework 18, with an elongated U shape, that enables the components to extend from fender 60 to fender 60. This is the in lateral direction to enable connection with the vehicle fenders 60. This is seen in FIGS. 2 and 4.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A front bumper assembly comprising:
a bumper;
a reinforcement member secured to the bumper for receiving a front nose fascia; and
a framework coupled with the reinforcement member, the frame work supporting the front nose fascia.

2. The front bumper assembly of claim 1, wherein the reinforcement member is welded to the bumper.

3. The front bumper assembly of claim 1, wherein the reinforcement member includes a plurality of bores for receiving fasteners to secure with the framework.

4. The front bumper assembly of claim 1, wherein the framework includes a plurality of channels for receiving pins from the front nose fascia.

5. The front bumper assembly of claim 4, wherein a clip secures to each pin to retain the front nose fascia on the framework.

6. The front bumper assembly of claim 1, wherein the framework has a ledge and an extending wall, the ledge coupled with the reinforcement member and the front nose fascia coupled with the wall.

7. The front bumper assembly of claim 1, wherein the reinforcement member secures to a peripheral portion of the framework.

8. The front bumper assembly of claim 1, wherein the framework includes bores for receiving fasteners for securing with the daytime running lights.

9. The front bumper assembly of claim 1 wherein the framework includes a channel for receiving the daytime running lights.
